(19) United States
(12) Patent Application Publication
(10) Pub. No.: US 2006/0179231 A1
(43) Pub. Date: Aug. 10, 2006

(54) System having cache memory and method of accessing

(75) Inventors: Willard S. Briggs, Boulder, CO (US); Amar Salaj Vattakandy, Longmont, CO (US)

Correspondence Address: LARSON NEWMAN ABEL POLANSKY & WHITE, LLP, 5914 WEST COURTYARD DRIVE, SUITE 265, AUSTIN, TX, 78730, US

(73) Assignee: Advanced Micron Devices, Inc.

(21) Appl. No.: 11/052,650

(22) Filed: Feb. 7, 2005

(51) Int. Cl. G06F 12/00

(52) U.S. Cl. 711/136; 711/122

(57) ABSTRACT

A system having an upper-level cache and a lower-level cache working in a victim mode is disclosed. The victim cache comprising a most recently used control module to identify a cache location having been most recently read as a least recently used cache location.

### FIELD OF THE DISCLOSURE

The present disclosure relates generally to memory systems, and more particularly to systems using cache memories.

### DESCRIPTION OF THE RELATED ART

Systems that utilize victim caches operate in cache write mode by transferring a cache line being overwritten in an upper-level cache to a lower-level victim cache for storage. During a read operation requested data is transferred from the victim cache to the higher-level cache in response to the requested data residing in a line of the victim cache, as indicated by a cache hit. A write to invalidate the cache line read from the victim cache occurs as part of the read operation. Invalidating the read cache line to allow the cache line to be identified by the cache controller as available for subsequent write operations.

### BRIEF DESCRIPTION OF THE DRAWINGS

The present disclosure may be better understood, and its numerous features and advantages made apparent to those skilled in the art by referencing the accompanying drawings.

FIG. 1 illustrates, in block diagram form, a system comprising a cache memory in accordance with a specific embodiment of the present disclosure;

FIG. 2 illustrates a timing diagram contrasting the present embodiment with previous techniques;

FIG. 3 illustrates, in block diagram form, the effects of a read hit and a write hit on the status of cache lines in a common cache row in accordance with a specific embodiment of the present disclosure;

FIGS. 4-7 illustrate in flow diagram form methods in accordance with the present disclosure.

The use of the same reference symbols in different drawings indicates similar or identical items.

### DETAILED DESCRIPTION OF THE DRAWINGS

A victim cache system is disclosed in accordance with a specific embodiment of the present disclosure. In one embodiment, a Level 1 (L1) and Level 2 (L2) cache work together such that the L2 cache is a victim cache that stores data evicted from the L1 cache. In accordance with a specific embodiment of the present disclosure, when data is written from the L1 cache to the L2 cache, the cache line being written is identified in the MRU array as the most recently used (MRU) cache line in its cache row. A data read to the victim cache, however, results in the cache line being read from the victim cache as being identified in the MRU array as the least recently used (LRU) line in its cache row. Identifying the cache line just read from the cache as being the least recently used line in the row has a similar effect as invalidating the line in the TAG array, in that the most recently read cache line is subject to being overwritten before any other valid line of the cache row. This is advantageous over previous systems using victim caches because the data of read cache lines remains available for a subsequent read in case it is needed. For example, if the initial read transfer of victim cache data is aborted the cache line can be subsequently read from the victim cache because it has not been invalidated. Another advantage is that the victim cache bandwidth is improved because there is no need for a separate write cycle to invalidate the TAG location for the read cache line.

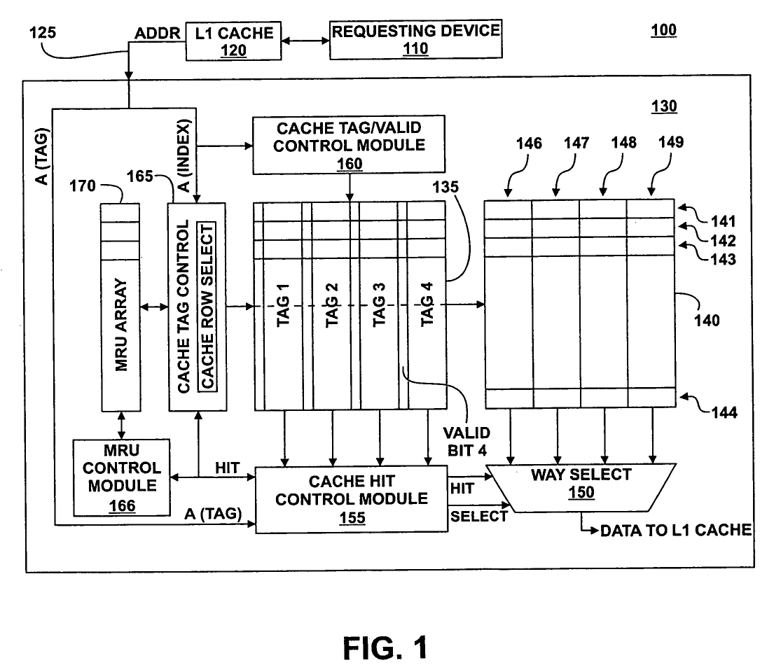

As used herein the term row, or cache row, refers to the set of cache lines that is selected based upon an index portion, see A(INDEX) in FIG. 1, of the current address. For example, reference numbers 141, 142, and 143 represent cache rows, each having four cache lines. These and other specific embodiments of the present disclosure will be better understood with reference to the FIGS. 1-7 herein.

FIG. 1 illustrates a System 100 in accordance with a specific embodiment of the present disclosure. System 100 includes a Requesting Device 110, a Level 1 Cache 120, and a Level 2 victim Cache 130. System 100 can represent a system-on-a-chip (SOC) system or a multi-component system. In the case of a multi-component system portions of devices 110, cache 120 and cache 130 can reside on different semiconductor substrates. In one embodiment device 110, and cache 120 are on a common semiconductor substrate, while some or none of cache 130 is manufactured onto a different semiconductor substrate. When System 100 includes multiple components, they may be interconnected using a printed circuit board, multi-chip module or other substrate capable of supporting and interconnecting the components.

In operation, Requesting Device 110 has a bus port that is electrically connected to a bus port of the L1 Cache 120. In a specific embodiment, the Requesting Device 110 can be a central processing unit of a microcontroller. During a data access operation, the Requesting Device 110 will request that information be read (received) or written (transmitted). Either a read or write access operation can result in data being written to caches 120 and 130.

Cache Module 120 will provide the data requested by Requesting Device 110 if a hit occurs at Cache Module 120. If a miss occurs at Cache Module 120, i.e. the requested data is not present, the data will be written to Cache Module 120 from either Victim Cache 130 or from a another memory location (not shown) such as system memory. For example, if requested data is not present in either Cache 120 or Cache 130 the data will be received from a different memory location. If in response to receiving data from a different memory location it is necessary to overwrite data at a cache line of Cache 120, the data to be overwritten will first be evicted from the L1 Cache 120 and written to the Victim Cache 130 for storage Victim Cache 130 identifies a cache line receiving evicted data as the most recently used cache line in response to its being written.

If a cache hit for data requested by Requesting Device 110 occurs in the Victim Cache 130, instead of external memory or the L1 Cache 120, the requested data is provided from the Victim Cache 130 to the L1 Cache 120 for storage. This read of the a cache line within the Victim Cache 130 results in the read cache line being identified as least recently used.

The Victim Cache 130 is illustrated to include Memory Array 140, Tag/Valid Bit Array 135, Cache Tag Control Portion 165, Cache Hit Module 155, Most Recently Used (MRU) Control Module 166, MRU Array 170, and Way Select Module Portion 150.

Bus 125 couples the L1 cache 120 to the Victim cache 130 to provide address information that includes a TAG portion and an INDEX portion from the L1 Cache 120 to the Victim Cache 130. It will be appreciated that additional data and control busses exist, and that only the address bus is illustrated for purposes of discussion. The portion of Bus 125 that transmits address information used to identify a specific set of cache lines of memory array 135 is labeled A(INDEX) and is connected to Cache Tag Control 165. Address information used to select a specific way of a cache row is labeled A(TAG) and is provided to the Cache Hit Module Portion 155. The Memory Array Portion 140 comprises cache rows 141-144, and is illustrated to further comprise four ways, ways 146-149. Way Select Module 150 is connected to the Cache Memory Array 140 to receive a signal to select data associated with one of the ways of memory array 140 to be provided to the L1 Cache 120 in response to a hit in the Victim Cache 130.

The Cache Tag Controller 165 selects one of the cache rows of the Cache Memory Array 140 as well as the TAG and valid bits in Array 135 associated with the row. If in response to receiving a specific address it is determined that the current address TAG, A(TAG), is stored within the Cache Tag/Valid Bit Array 135, signals will be asserted by the Cache Hit Module 155 and provided to the MRU Control 166 and the Way Select module 150, resulting in data being provided from the Victim Cache 130 to the L1 Cache 120 and in an update of the MRU register.

During a write operation the MRU Control Module 166 will update the MRU Array 170 to indicate that the line being written is the most recently used line within its row.

During a read operation the MRU Control Module 166 will update the MRU Array 170 to indicate that the line being read is the least recently used cache line within its row. By indicating the read line is the least recently used line, when it is actually the most recently accessed, it is assured that the line just read will have the highest likelihood of being overwritten during a subsequent write operation, while maintaining the availability of the recently read data prior to being overwritten. This is beneficial over previous systems that invalidate the victim caches TAG for a line once the cache line data is read, thereby preventing a subsequent data read of the cache line if the original data is subsequently needed from the victim cache, such as if the original read of the cache line had to be aborted.

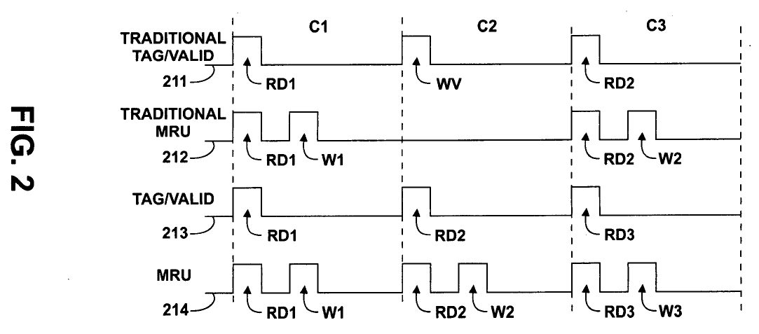

Improved bandwidth can also be realized using the disclosed system because a separate write to the TAG/Valid Array 135 to invalidate the cache line is not needed. This can be better understood with reference to FIG. 2.

FIG. 2 illustrates a timing diagram for a read to a previous victim cache, and a read to the Victim Cache 130 in accordance with the present disclosure. Signal 211 represents accesses to TAG/valid bits of the victim cache in a previous system, and signal 212 represents accesses to the MRU indicators of the MRU array of a previous system. Specifically, during a first cycle (C1) of a read to a previous victim array the TAGs and invalid bits of the selected cache row are read as represented by pulse RD1 of signal 211. During the same cycle, the MRU indicators for the accessed row are read and written, as represented by pulses RD1 and W1 of signal 212. Because the invalid bit is in the speed path for accessing data stored in the victim cache, and because the TAG/INVALID array 135 is much larger than the MRU array, it is not generally practical to write back to the invalid bit of the array 135 in the same cycle. Instead, the valid bit is written to indicate the data of a specific line within the cache row is invalidated during a second cycle of the same read operation. The next read of the victim cache cannot occur until the third cycle (C3).

Signal 213 represents accesses to TAG/valid bits of the TAG in the disclosed system. Signal 214 represents accesses to the MRU indicators of the MRU array. Specifically, the TAG and invalid bits of the selected cache row are read during C1 at a time represented by pulse RD1 of signal 213. During the same cycle, the MRU indicators for the accessed row are read and written, as represented by signal 214 pulses RD1 and W1. Because the MRU array is written back during C1 a second read operation can occur at cycle C2, thereby improving the read bandwidth of the Victim Cache 130.

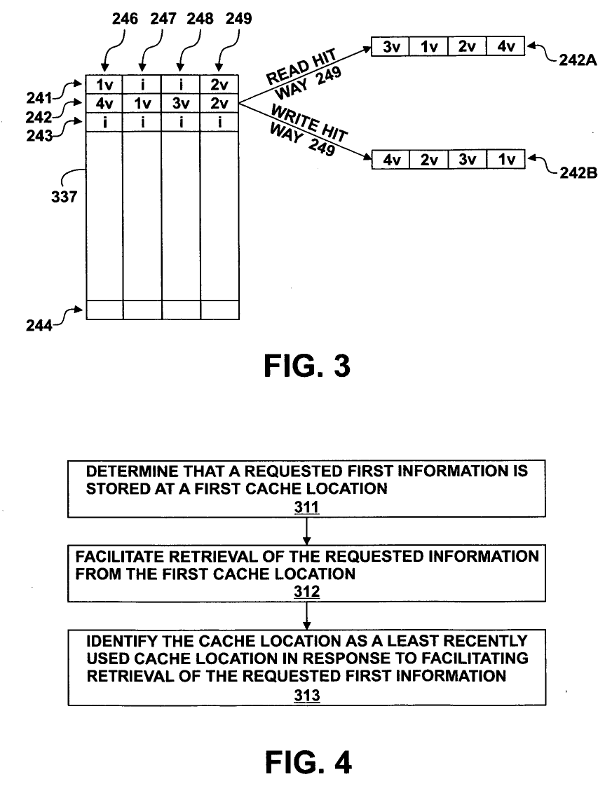

FIG. 3 facilitates understanding of the Victim Cache 130 by illustrating how read and write operations to the Victim Cache 130 effect MRU and valid bits of a cache rows. Specifically, FIG. 3 illustrates an array 337 having rows and columns corresponding to the rows and ways of Victim Cache 130 of FIG. 1. For example, rows 241-244 correspond to cache rows 141-144, while columns 246-249 correspond to ways 146-149. Each cache line of array 337 contains the letter “i” or “v”, wherein the letter “i” indicates that data associated with that cache line is invalid and the letter “v” indicates that data associated with that cache line is valid. Those lines identified as containing valid data also contain a numeral from 1 to 4 indicating its most recently used status, where a 1 represents data most recently used and a 4 represents data least recently used.

The path from Line 242 to Line 242A of FIG. 3 represents a data read of a line associated with row 241, column 249, while path from Line 242 to Line 242B represents a data write of the cache line associated with row 242, column 249.

During a read operation to row 142, way 149, the MRU values associated with the cache row of 142 are modified so that the recently read line contains the value 4, and thereby is identified as the least recently used line. During a write operation to row 142, way 149, the MRU values associated with the cache row 142 are modified so that the recently written line contains the value 1, an thereby is identified as the most recently used line.

The manner in which a specific cache line's use status is stored can be accomplished in many ways. For example, each cache line can be associated with a memory location having sufficient size to indicate its current use ranking. For a cache row having four cache lines this would require four two-bit locations. Alternatively, a cache row having four cache lines could use a pseudo-ranking scheme using only three bits. In such a scheme there are two non-overlapping sets of cache lines identified, each non-overlapping set representing two of the four cache lines. A first bit of the three bits used to implement the pseudo ranking scheme is asserted to indicate the first set contains the most recently used cache line, and negated to indicate the second set contains the most recently used cache line. The remaining two bits of the pseudo-ranking scheme are asserted or negated to indicate which cache line within a respective set is the most recently accessed. It will be appreciated that this scheme allows identification of the most recently and least recently used cache line with in a row.

FIG. 4 illustrates, in flow diagram form, a method in accordance with the present embodiment. At step 311, a determination is made as part of a read operation that requested first information is stored at a first cache location, such as a cache line, within the victim cache, i.e. a hit.

At step 312, in response to a successful hit at step 311, retrieval of the requested information is facilitated from the first cache location. Referring to FIG. 1, the requested information is selected through the Way Select Module 150 based upon the cache row selected by the Cache Row Select module of the Cache TAG Control 165 and the select signal provided by the Cache Hit Module 155 in response to a successful TAG hit.

At step 313, in response to a successful hit at step 311, the cache location from which the requested information was accessed will be identified as being the least recently used cache location in response to being read. In this manner the data remains accessible, but is subject to being overwritten the next time information needs to be stored at that cache tag location.

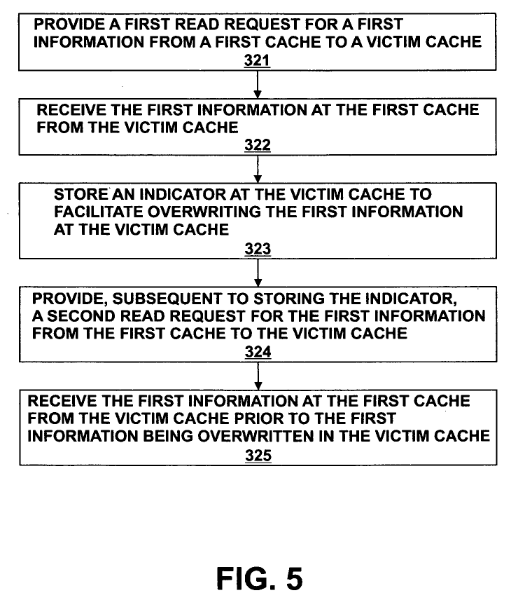

FIG. 5 illustrates yet another embodiment of the present disclosure. At step 321, a first read request for information from a victim cache is provided to a victim cache, wherein the information is to be provided to an upper-level cache. For example, as part of a victim cache system, a primary request for data is made to the upper-level cache and provided secondarily to the victim cache. Note that this secondary request can be made by memory control considered part of the upper-level cache itself, or by memory control considered separate from the upper-level cache. Referring to FIG. 1, the L1 Cache 120, or a memory controller not illustrated, could provide a read request to the L2 Cache 130).

At step 322, the first information is received at the first cache from the victim cache. For example, referring to FIG. 1, the L2 Cache 130, e.g. the victim cache, will provide the data to the L1 Cache 120 once selected.

At step 323, an indicator is stored at the victim cache to facilitate overwriting the first information at the victim cache. It will be appreciated that once a read of the information from the L2 victim cache 130 has occurred, that there is a strong presumption the data just read resides within the L1 Cache 120, which requested the information. Therefore an indicator, such as a least recently used indicator, can be applied to the location previously storing the first information to facilitate a subsequent overwriting of the data.

At step 324, a second read request for the same information is provided to the L2 cache. In response to receiving this request, the information can be received at the first cache from the victim cache, as indicated at step 325 prior to the first information having ever been overwritten by the victim cache. This represents one improvement over the previous methods in that once a victim cache location is read; its data is not invalidated.

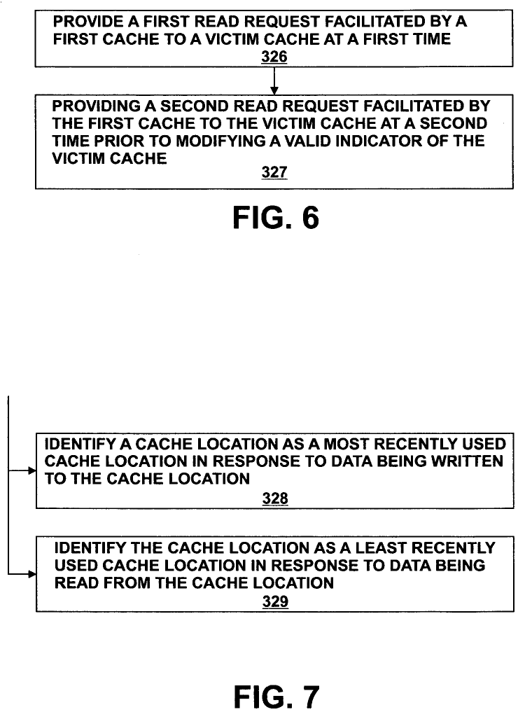

FIG. 6 illustrates, in block diagram form, a method in accordance with the present disclosure. At step 326, a first read request occurs at a first time that is facilitated by an upper-level cache to a victim cache at a first time. It will be appreciated that the upper-level cache facilitates the read request to the victim cache that actual completion of the victim cache read is predicated on whether the requested data resides in the upper level cache. At step 327, a second read request occurs at a second time that is facilitated by the upper-level cache, and that during the duration between the time of the first read and the time of the second read that no modification of a valid indicator occurs. More specifically, the data read by the first read is not invalidated by an intervening write to the TAG/INVALID register.

FIG. 7 illustrates, in flow diagram form, a method in accordance with a specific embodiment to the present disclosure. Step 328 will be executed in response to data being written to a cache location of the victim cache, whereby the cache location is identified as a most recently used cache location. Step 329 will be executed in response to data being read from the cache location of the victim cache, whereby the cache location is identified as a least recently used cache location.

In the preceding detailed description, reference has been made to the accompanying drawings that form a part hereof, and in which are shown by way of illustration specific embodiments in which the invention may be practiced. These embodiments and certain variants thereof, have been described in sufficient detail to enable those skilled in the art to practice the invention. For example, it will be appreciated that although separate address connections are illustrated connecting device 110 to device 120 and device 120 to device 130, that a common set of address connections can shared by the three devices. It is to be understood that other suitable embodiments may be utilized. In addition, it will be appreciated that the functional portions shown in the figures could be further combined or divided in a number of manners without departing from the spirit or scope of the invention. For example, the control portions of the victim cache 130 can be formed on a common substrate with the L1 Cache 120 and Requesting Device separate from the memory array 135. In such an embodiment, the valid bits associated with each cache line can be stored as part of the control portions or as part of the memory array 135. Further, it will be appreciated that data stored within the described cache areas can be instruction-type data or data-type data, i.e. non-instruction data. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method comprising the steps of:
determining a requested first information is stored at a first cache location, the first cache location associated with a first way in a first cache row of a first cache;
facilitating retrieval of the requested information from the first cache location;
identifying the first cache location as a least recently used location in response to facilitating retrieval of the requested first information.

2. The method of claim 1 wherein the first cache is a victim cache.

3. The method of claim 2, wherein the first cache is a level 2 victim cache.

4. The method of claim 1 further comprising:
determining the requested first information is unavailable at a second cache.

5. The method of claim 4, wherein determining the requested information is unavailable further comprises determining the request is unavailable prior to facilitating retrieval of the requested first information.

6. The method of claim 5 further comprising:
providing a request for the requested first information from a central processing unit.

7. A method comprising:
providing a first read request for a first information to a victim cache;
receiving the first information at a first cache from the victim cache;
storing an indicator at the victim cache to facilitate overwriting the first information at the victim cache;
providing, subsequent to storing the indicator, a second read request for the first information to the victim cache; and
receiving the first information at the first cache from the victim cache prior to the first information being overwritten in the victim cache.

8. The method of claim 7, wherein the indicator is a least recently used indicator.

9. The method of claim 7, wherein the first information is one of a data type or an instruction type.

10. A method comprising:
providing a first read request facilitated by a first cache to a victim cache at a first time, wherein the first read request is to access a first cache line of the victim cache; and
providing a second read request facilitated by the first cache to the victim cache at a second time prior to modifying a valid indicator of the victim cache, wherein the first read request is to access a second cache line of the victim cache.

11. The method of claim 10, wherein the victim cache information comprises victim cache control information

12. The method of claim 11, wherein the victim cache control information comprises a valid data indicator.

13. The method of claim 10, wherein the victim cache is a level 2 cache.

14. A method comprising the steps of:
identifying a cache location as a most recently used cache location in response to data being written to the cache location; and
identifying the cache location as a least recently used cache location in response to data being read from the cache location.

15. The method of claim 14 wherein the first cache is a victim cache.

16. The method of claim 15, wherein the first cache is a level 2 victim cache.

17. A system comprising:
a data processor comprising a bus port to access cache data;
a first cache comprising a first bus port coupled to the bus port of the data processor, and a second bus port;
a second cache comprising a bus port coupled to the second bus port of the data processor; wherein the second cache is to provide data to the data processor through the second cache, the second cache comprising
a most recently used control module to identify a cache location having been most recently read as a least recently used cache location.

18. The system of claim 17 further comprising a register location operably coupled to the most recently used control module to store a most recently used indicator for the cache location.

19. The system of claim 18 where in the most recently used control module is further to identify a cache location having been most recently written as a most recently used cache location.

20. The system of claim 17 where in the most recently used control module is further to identify a cache location having been most recently written as a most recently used cache location.
